(19) United States
(12) Patent Application Publication
(10) Pub. No.: US 2004/0133548 A1
(43) Pub. Date: Jul. 8, 2004

(54) Electronic Files Digital Rights Management.

(75) Inventors: Alex Fielding, Half Moon Bay, CA (US); Michael James Connor, El Dorado Hills, CA (US)

Correspondence Address: Michael James Connor, 4359 Cordero Drive, El Dorado Hills, CA, 95762

(73) Assignees: Alex Fielding, Half Moon Bay, CA (US); Michael James Connor, El Dorado Hills, CA (US)

(21) Appl. No.: 10/707,442

(22) Filed: Dec. 15, 2003

(51) Int. Cl. G06F 7/00

(52) U.S. Cl. 707/1

(57) ABSTRACT

This invention uses file hash signatures, including but not limited to those generated from MD5, MD2, SHA-1, SHA-224, SHA-256, SHA-384, SHA-512 and FIPS 180-2 files, and various file comparison and matching technologies in a real time or near real time solution to determine if digital content has been stolen or otherwise illegally, opened, transferred, viewed, played or copied. Once digital content has been analyzed (match or no match) one or more follow-on actions can be taken with respect to the content based on preferences established by the owner/authorized agent of the digital content. These include blocking the copy or playback process, preventing transferring of files over a network or between systems, notification to one or more users about the theft of illegal use and/or instruction(s) to the unauthorized user. Digital content includes but is not limited to digital audio, digital picture and video, and digital documentation.

### CROSS REFERENCE TO RELATED APPLICATIONS

U.S. Pat. No. 5,425,029 June, 1995 Hluchyj et al. 370/235. U.S. Pat. No. 5,568,487 October, 1996 Sitbon et al. 709/230. U.S. Pat. No. 5,682,534 October, 1997 Kapoor et al. 709/203. U.S. Pat. No. 5,727,002 March, 1998 Miller et al. 709/237. U.S. Pat. No. 5,822,524 October, 1998 Chen et al. 709/203. U.S. Pat. No. 5,854,841 December, 1998 Nakata et al. 709/203. U.S. Pat. No. 5,889,954 March, 1999 Gessel et al. 709/223. U.S. Pat. No. 5,903,724 May, 1999 Takamoto et al. 709/200. U.S. Pat. No. 6,021,440 February, 2000 Post et al. 709/231. U.S. Pat. No. 6,046,979 April, 2000 Bauman 370/229. U.S. Pat. No. 6,061,796 May, 2000 Chen et al. 709/225. U.S. Pat. No. 6,269,467 July, 2001 Chang et al. 716/1. U.S. Pat. No. 6,519,636 February, 2003 Engel et al. 709/223.

### BACKGROUND OF INVENTION

Illegal distribution and transfer of copyrighted digital audio, video, picture, and document content online is a huge problem especially to the commercial businesses that are most affected by theft/unauthorized duplication, replication, or transfer of said content. This invention makes it possible to significantly reduce the illegal distribution of stolen music, video, audio, picture and documents over the Internet, electronic networks or computer systems.

Every digital file has a unique hash. Thus, a song mastered on a CD that is then copied illegally and transferred over the Internet has a unique hash “fingerprint” from the same song if copied legally for legitimate purposes. By creating a database of illegally copied music it is possible to use the unique hash fingerprints of each music file to help identify music, which is being illegally copied and distributed. It is important to note that music legally purchased over the Internet has a different hash “Fingerprint” than that copied illegally. Understanding this now makes it possible to identify music files that have been illegally copied and transferred via the Internet. Similarly, creating databases of stolen picture, video, audio or other documents together with their associated hash “Fingerprints” also makes it possible to identify illegal transfer and use of these files.

The hash fingerprints have been used in court cases as a way to prove that one file was identical to another file that was an illegal copy. This invention recognizes that there is a better and earlier way to identify the illegally copied content sooner and stop it before the damaging effects of digital theft could be realized. It also became clear that the only way to effectively combat the rising costs of stolen content would be to create a system, method, and apparatus that could work effectively and efficiently at a network level and computer system level. One such approach is to have a specific method that could have the network communicate with the operating system and operating system communicate with specific applications to identify stolen content that is being transferred over the Internet. Once identified the illegal distribution would be stopped dynamically from completing the transfer. This same approach could be used to prevent illegally copied files from being executed on computer systems and other digital devices such as digital audio players like Apple Computer's iPod or Diamond MultiMedia S3's Rio or even digital hard disc recorders and digital disk recorders.

One problem that became clear was that once content was recognized, there was no way to allow a user to legitimize the content they had previously downloaded or were in the process of downloading. One such way could be to allow them to purchase the content at an online music store or to purchase it directly on their computer system whereby their copy of the illegal distribution could be re-encoded and serialized or otherwise encrypted to match the new owner of the copy after a purchase. Another option might be, in the case of documentation, to prompt the user to ask for permission to open a document that they are not authorized to open.

Positive identification, in the form of using a digital fingerprint, such as a hash (Md5, Md2, SHA-1, etc), of files while in transit has not been addressed by any of the prior art. The recent speed increases of processors in firewalls, IDS (Intrusion Detection Systems), and IPS (Intrusion Prevention Systems) has only recently made it possible to implement such a system without slowing down the transmission of information while performing such a task on a network appliance.

In addition, no prior art exists in this space partly because there was no mechanism for owners of digital information to identify a specific file rather than a specific file type or document data in a way that was conclusive and could be court accepted. Now hash signatures such as MD5 have been used in court cases and are proven methods of identification and no prior art takes into account a mechanism for using these fingerprints to identify files in transit or files in the process of being executed and perform an action based on that data.

The RIAA has used hash fingerprints in a database that contains only those fingerprints for identification purposes of stolen audio content such as Mp3s. The process used is not automatic and not scalable or usable on a corporate network or by an operating system or user application. Also, the RIAAs process does not take into account other types of digital content such as video, documents, or pictures.

### SUMMARY OF INVENTION

This invention relates to the field of identifying and controlling digital data such as digital audio, digital video, and digital documents such as one or more of the following: mp2, mp3, mp4, AAC, dv, MPEG1, MPEG2, MPEG3, MPEG4, JPEG, TIFF, GIF, .doc, .ppt, .xls and others sent to and received from a computer system or application connected to a network, particularly over one or more of the following: the internet, intranet, cable, wireless and any other of packet switching networks.

More specifically, the invention relates to a way to control how data is communicated to an application on the network and how packets received from the network are passed to the application and how an operating system identifies and controls, through an application, the use of the data through a series of checks and balances and a bi-directional rule set containing hash values or fingerprints of each file as identified by ourselves or our potential partners such as the RIAA or ASCAP or other media control organizations that work on behalf of the record or video industry. This invention also relates to how the digital data is transmitted over the network by storing the application providing the hash database of stolen audio or video data on a firewall application whereby the files are checked in transit to verify that they are not stolen and therefore can be passed; if they are stolen, the download or upload is stopped in transit and other options may be presented to the user at that time. If the file is executed on a computer system, the user may be asked to purchase the music from an online music store or to legitimize the copy contained on their computer wherein the song is reencoded at a charge to the user on the user computer system.

### BRIEF DESCRIPTION OF DRAWINGS

FIG. 1 is a functional block diagram of the method of computing a file hash signature and comparing it to a database of known file signatures; and

FIG. 2 is a functional block diagram of a computer system in which is installed digital content distribution control software; and

FIG. 3 is a flow chart illustrating the method of operation of the system of FIG. 2; and

FIG. 4 is a flow chart illustrating the method of one operation of the system of FIG. 3; and

FIG. 5 is a flow chart illustrating the method of one operation of the system of FIG. 3; and

FIG. 6 is a flow chart illustrating the method of one operation of the system of FIG. 4.

### DETAILED DESCRIPTION

For the purpose of illustration, the following example is described with reference to the Apple Macintosh OS X.TM. series of operating systems, although it will be appreciated that the invention is also applicable to other operating systems including Microsoft Windows.TM. Series operating systems, Apple Macintosh 9 systems, Linux, Unix, SCO, BSD, FreeBSD, Microsoft Windows CE.TM., Microsoft Windows NT.TM., Microsoft Windows XP.TM., IBM AIX and OS/2.

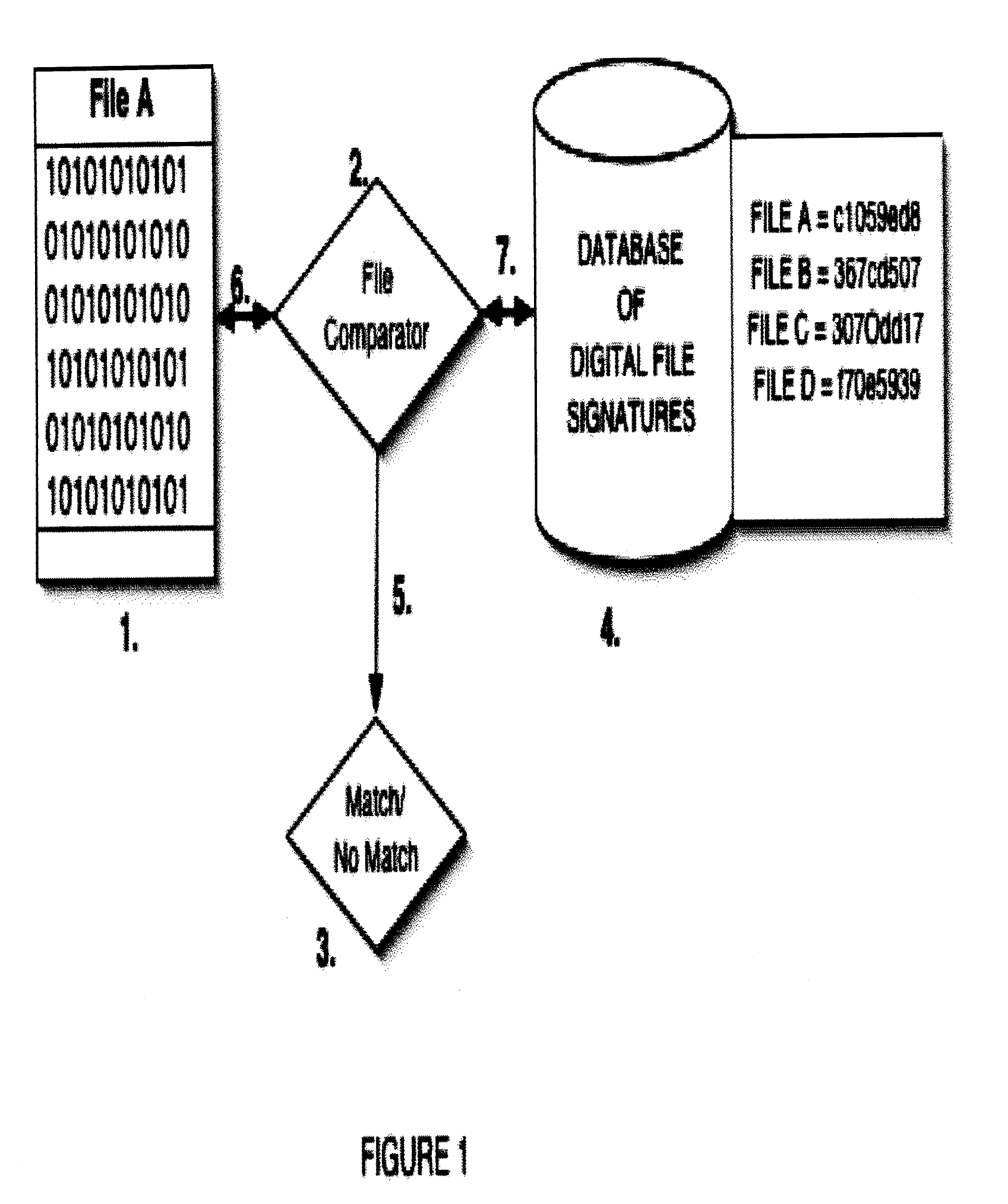

With reference to FIG. 1, a method contained inside of a computer system is described as containing a file 1 that is being interrogated by a file comparator process 2 via an electronic link 6 to compute a hash signature and compare said signature to those contained in a database containing digital content file signatures 4. The logical link 7 connecting the two processes and the file comparator 2 returning a result 3 of MATCH or NO MATCH.

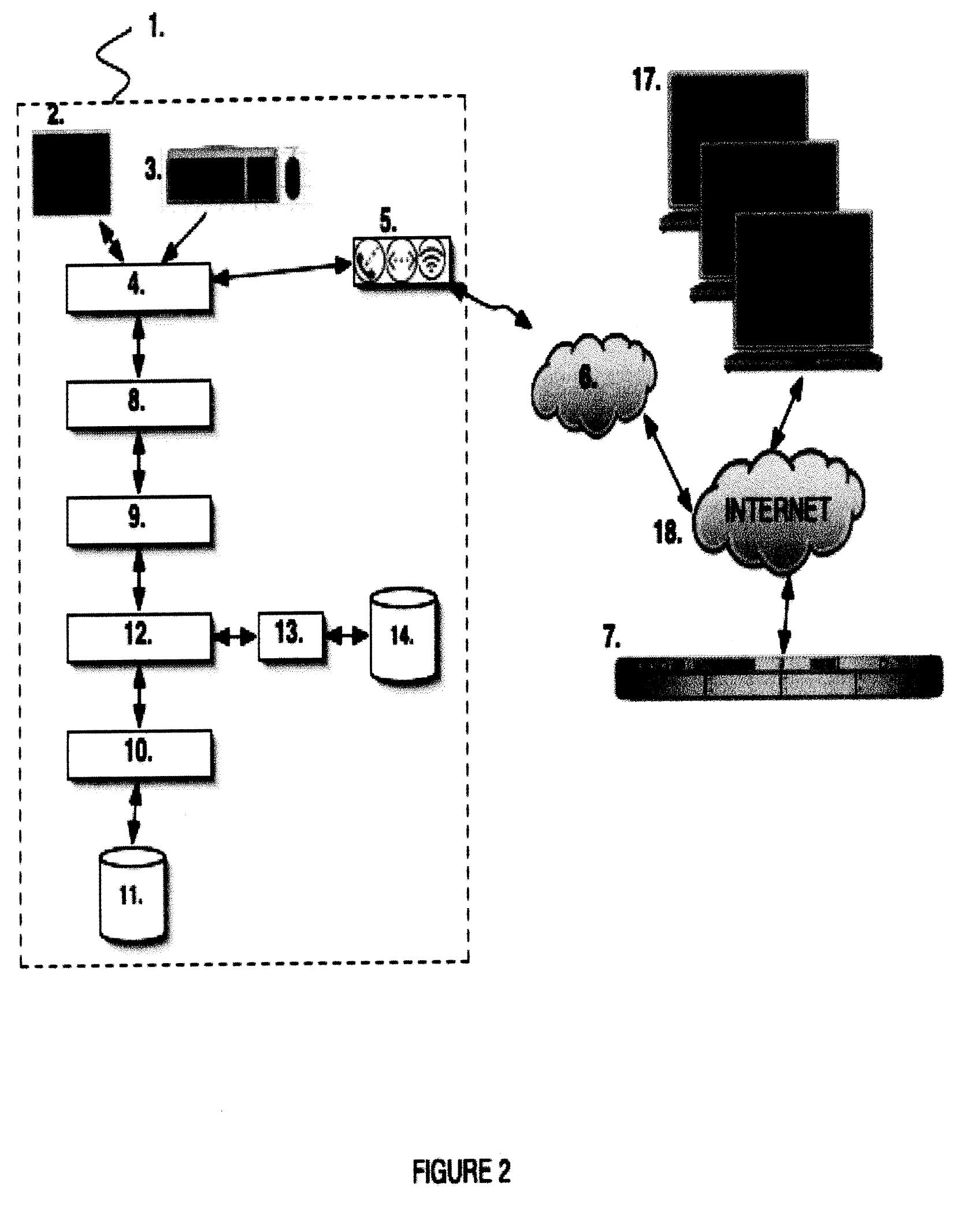

With reference to FIG. 2, an end user computer 1 has a display 2 and a keyboard 3. The computer 1 additionally has a processing unit and a memory which provide (in functional terms) a graphical user interface layer 4 which provides data to the display 2 and receives data from the keyboard 3. The graphical user interface layer 4 is able to communicate with other computers via a network interface 5 and a network 6. A network manager 7 controls the network.

Beneath the graphical user interface layer 4, the CPU runs a number of user applications. In FIG. 2, only a single application 8 is illustrated and may be, for example, Apple iTunes.TM. The application 8 communicates with a file system 9, which forms part of the Apple Macintosh OS X.TM. Operating System and which is arranged to handle file access requests generated by the application 8. These access requests include file open requests, file save requests, file copy requests, etc. The lowermost layer of the operating system is the disk controller driver 10, which communicates with and controls the computer's hard disk drive 11. The disk controller driver 10 also forms part of the Apple Macintosh OS X.TM. Operating System.

Located between the file system 9 and the disk controller driver 10 is a file system driver 12, which intercepts file system events generated by the file system 9. The role of the file system driver 12 is to co-ordinate digital content operations for data being written to, or read from, the hard disk drive 11. In dependence upon certain screening operations to be described below, the file system driver 12 enables file system events to proceed normally or prevents file system events and issues appropriate alert messages to the file system 9.

The file system driver 12 is functionally connected to an ACE (Analytic Control Engine) controller 13, such that file system events received by the file system driver 12 are relayed to the ACE controller 13. The ACE controller is associated with a database 14 which contain a set of “signatures” previously determined for respective digital files. For the purposes of this example, the signature used is a checksum derived using a suitable checksum calculation algorithm, such as the US Department of Defense Secure Hash Algorithm (SHA, SHA-1, SHA-224), MD5, MD2, or the older CRC 32 algorithm or other open source or proprietary algorithm capable of generating a hash signature value deemed acceptable to determine that one file is an identical copy of another file.

The database 14 contains a set of signatures derived for known digital content. Updates may be provided by way of floppy disks, CD, DVD, flash drive, FireWire, USB, or directly by downloading them from a remote server 17 connected to the Internet 18.

Only the network manager 7 and/or authorized computer administrator has the authority to modify this database 14 using signatures of digital content such as MP3, MP4, AAC, JPEG, GIF, TIFF, MPEG, DVD, etc.

Upon receipt of a file system event, the ACE controller 13 first analyses the file associated with the event (and which is intended to be written to the hard disk drive 11, read, copied, etc) to determine if the file matches that of a file identified to match content in the database 14.

The ACE controller 13 scans the database 14 to determine whether or not the corresponding signature is present in that database 14. If the signature is found there, the ACE controller 13 reports this to the file system driver 12. The file system driver 12 in turn causes the system event to be suspended and causes an alert to be displayed to the user that known digital content was found. The file system driver 12 may also cause a report to be sent to the network manager 7 via the local network 6. The file system driver 12 quarantines the infected file on the hard disk drive 11.

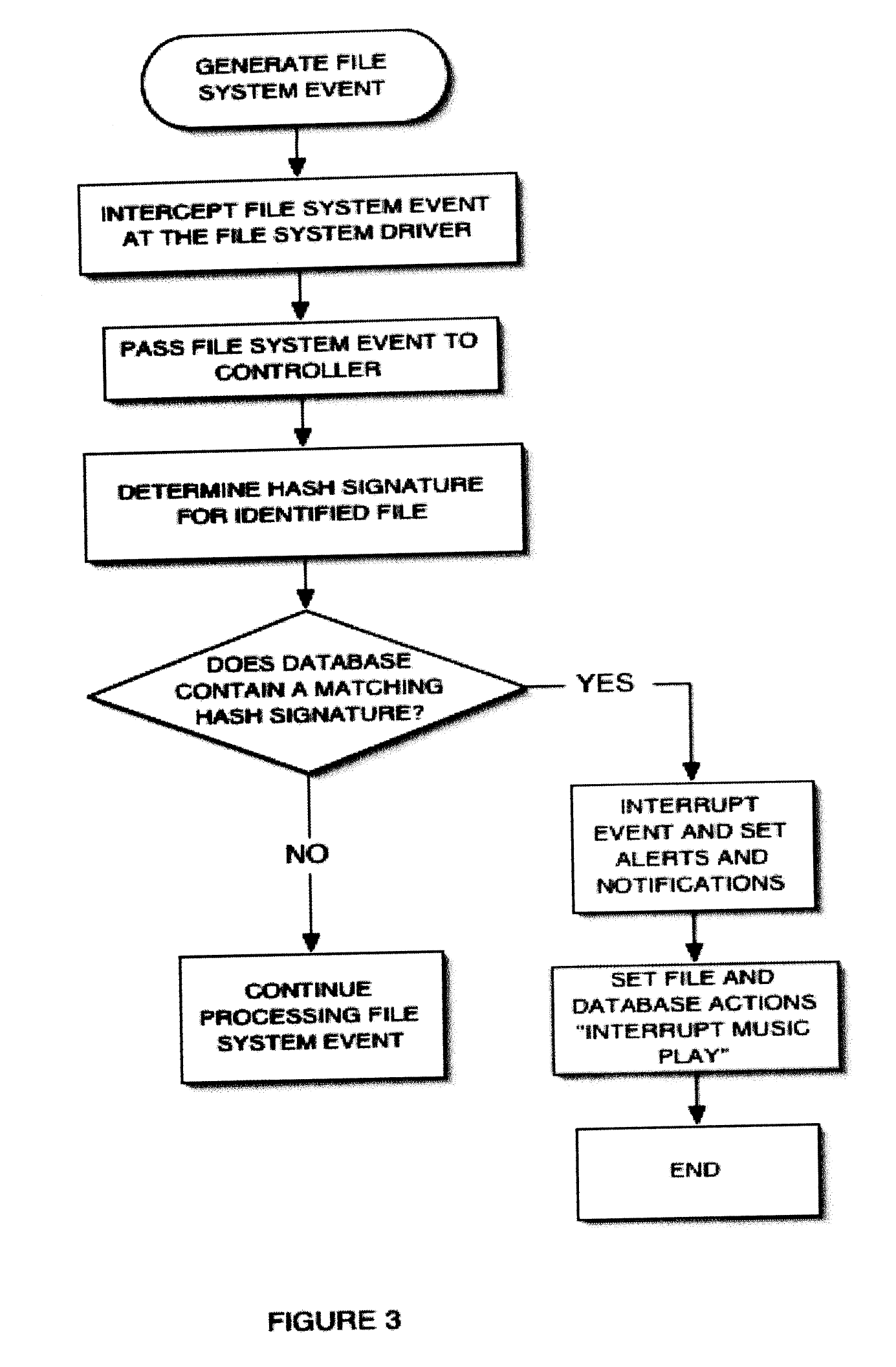

The file scanning system described above is further illustrated by reference to the flow chart of FIG. 3.

It will be appreciated by the person of skill in the art that various modifications may be made to the embodiment described above without departing from the scope of the present invention. For example, the file system driver 12 may make use of further digital content controllers including controllers arranged to screen files for illegitimately copied digital content other than hash identifiable. The file system driver 12 may also employ re-encoding systems data encryption systems.

It will also be appreciated that the file system driver 12 typically receives all file access traffic, and not only that relating to hard disk access. All access requests may be passed to the ACE controller 13 which may select only hard disk access requests for further processing or may also process other requests relating to, but not limited to, floppy disk data transfers, network data transfers, DVD, DVD-R, DVD-RW, CDROM, CD-RW, CD-R data transfers, USB, USB 2.0, FireWire, FireWire 2, and associated peripheral flash storage devices.

It will also be appreciated that the file system driver 12 and file system 9 along with applications 8 and GUI 4 can be those related to hand held, cell phone, PDA, digital camera, digital storage, or other devices containing a method to process electronic data as described above. It is also appreciated that hard disk drive 11 can be any electronic storage device such as flash, FireWire IEEE 1394, USB, USB 2.0, FireWire 2.0, and other electronic storage devices such as SD, MD, CF, etc. It is also appreciated that keyboard 3 can be any input device such as a cell phone keypad, microphone, or other electronic interface to a computer system or electronic device via wired or wireless connection.

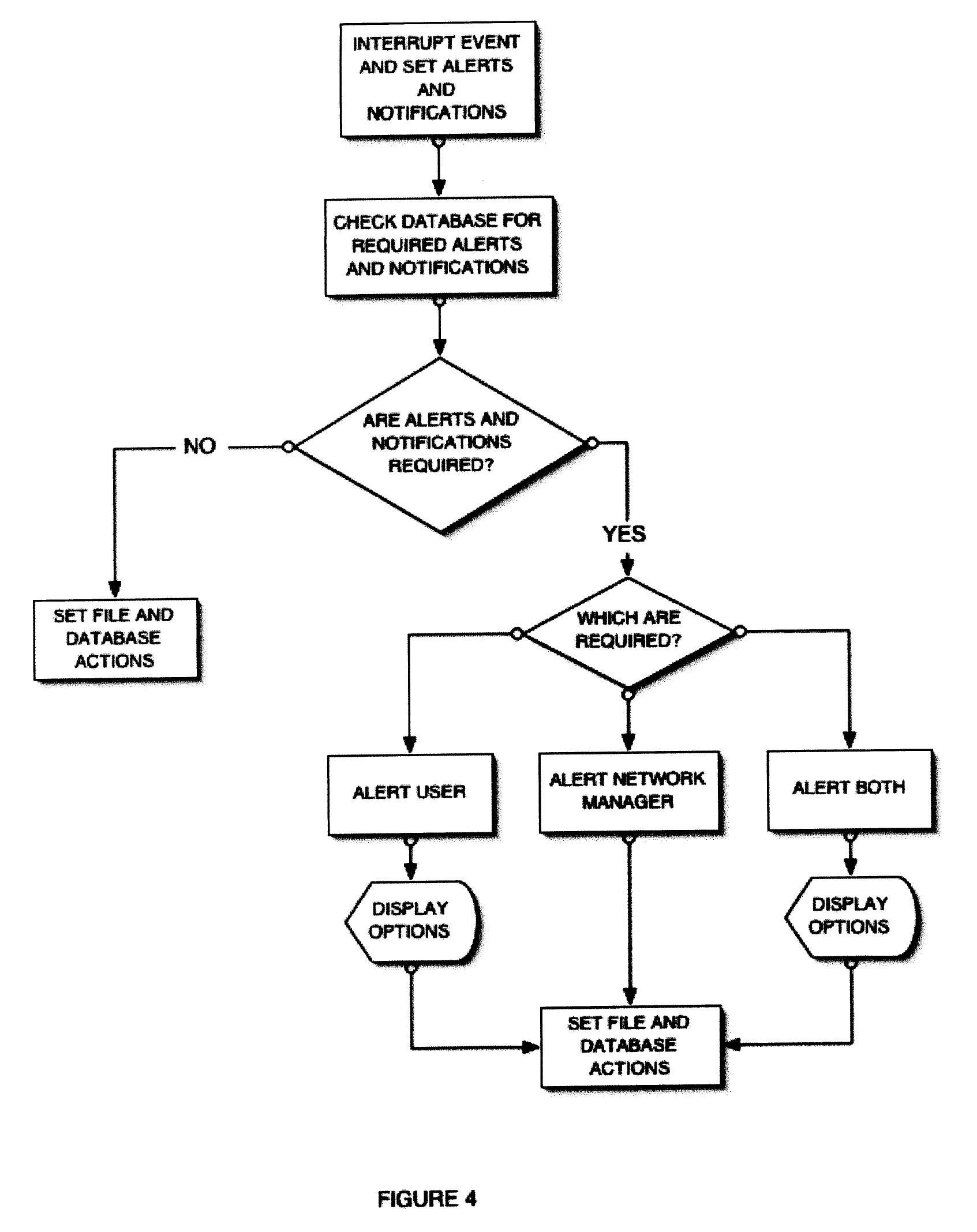

With reference to FIG. 4, a flow chart of the process illustrated in FIG. 3 “INTERRUPT EVENT AND SET ALERTS AND NOTIFICATIONS” is shown. The database referenced in FIG. 4 is the same database as referenced in claim 1 wherein one field in the said database contains alert and notification parameters.

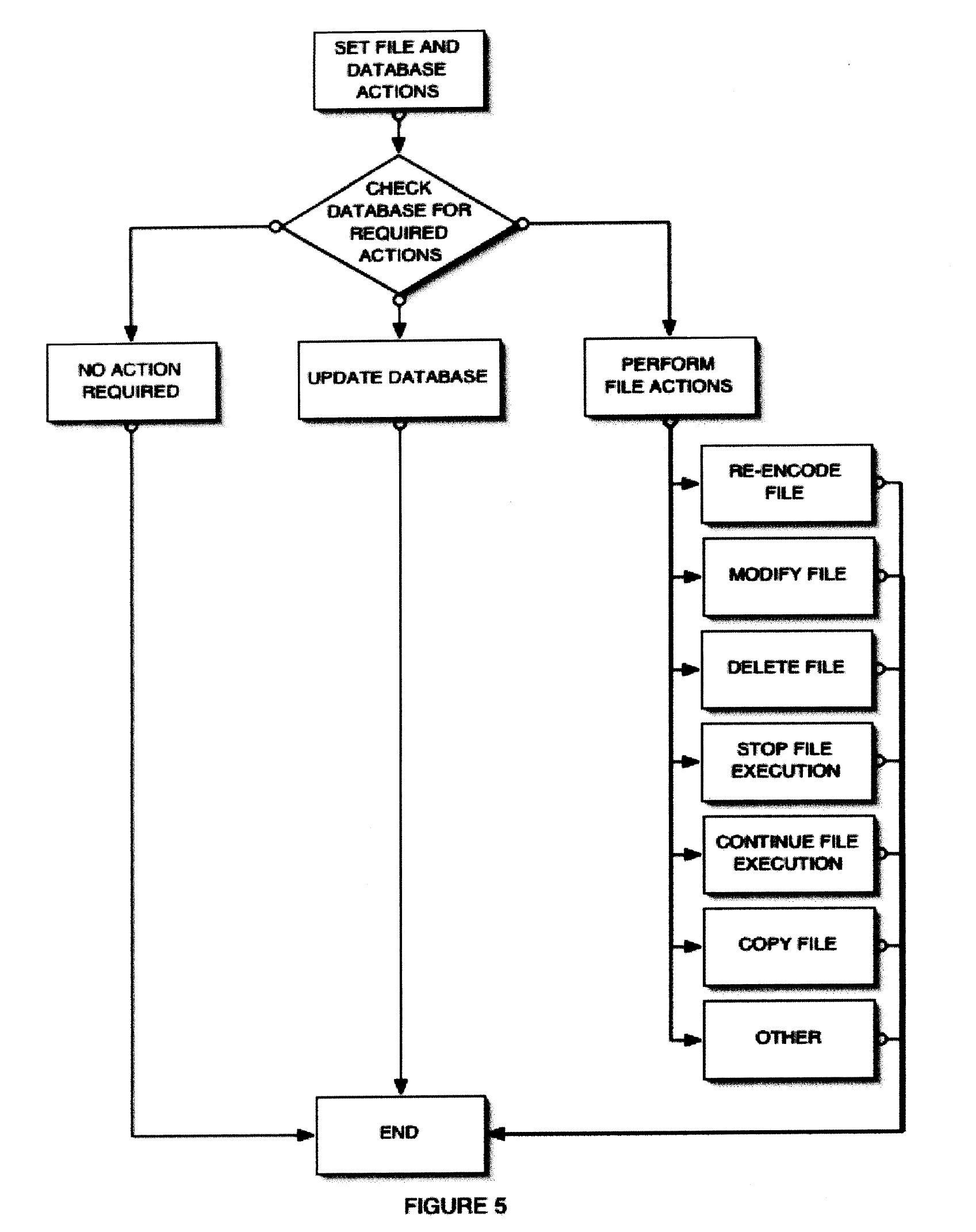

With reference to FIG. 5, a flow chart of the process illustrated in FIG. 3 “SET FILE AND DATABASE ACTIONS” is shown. The database referenced in FIG. 3 is the same database as referenced in claim 1 wherein one field in the said database contains file and database action parameters.

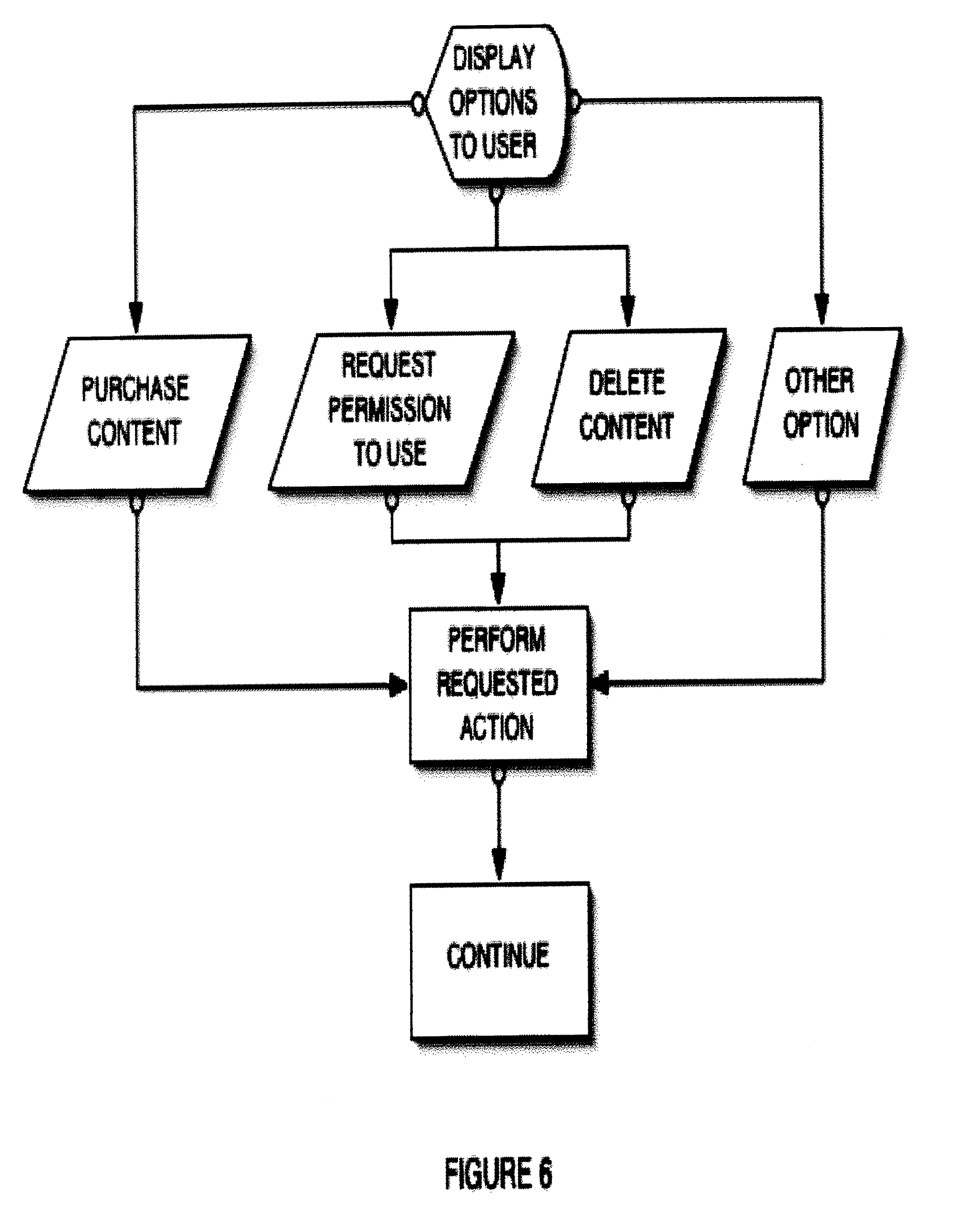

With reference to FIG. 6, a flow chart of the process illustrated in FIG. 4 “DISPLAY OPTIONS” is shown. The options shown are outlined in detail as they may be presented to a user of a computer system or other electronic device. This illustration is shown as one embodiment of options that may be presented; it does not outline every possible option as a network manager or remote system may define other options. These options will be presented in the database as claimed in claim 1 and said database will pass these parameters to the function in software.

1. A method of controlling distribution and use of a digital file, the method comprising:
defining a database of known file hash signatures;
determining a hash signature for a digital file; and
comparing the said signature with signatures contained in said database to determine if there is a match.

2. [Claim Reference]A method according to claim 1, wherein a match of signatures between the compared file and said database results in an action affecting the said compared file.

3. [Claim Reference]A method according to claim 1, wherein the result of a non-matching signature between the compared file and said database results in an action affecting the said compared file.

4. [Claim Reference]A method according to claim 1, wherein the result of a non-matching signature between the compared file and said database results in an action affecting the said database.

5. [Claim Reference]A method according to claim 1, wherein a match of signatures between the compared file and said database results in an action affecting the said database.

6. [Claim Reference]A method according to claim 1, wherein a match of signatures between the compared file and said database results in an alert or notification to a user of a computer system.

7. [Claim Reference]A method according to claim 6, wherein the said computer system is connected via an electronic link to a remote central computer.

8. [Claim Reference]A method according to claim 6, wherein the said computer system is connected via a peer to peer network.

9. [Claim Reference]A method according to claim 6, wherein the said computer system is not connected to a network.

10. [Claim Reference]A method according to claim 6, wherein the said computer system is connected to a wireless network.

11. [Claim Reference]A method according to claim 1, wherein the said database is updated via an electronic link between a computer hosting the database, where the comparing of the file is performed, and a remote central computer where a second master database is stored.

12. [Claim Reference]A method according to claim 11, wherein said second master database can be modified via a bidirectional relationship with said database.

13. [Claim Reference]A method according to claim 1, wherein said step of determining a signature for the said file and comparing that signature comprises deriving a signature of the file and comparing the derived signature with signatures in the said database.

14. [Claim Reference]A method according to claim 1, wherein said signature is derived using a hash computation.

15. Apparatus for determining and comparing the hash signature of a file, the apparatus comprising:
a memory storing a database of known file signatures; and
a data processor arranged to compare said file signatures to determine whether or not the signature matches one of the signatures contained in said database.

16. A computer memory encoded with executable instructions representing a computer program for causing computer system to:
maintain a database of known file signatures; and
determine whether or not a file has a signature matching one of the signatures contained in said database.

17. A network firewall connected through one or more network interfaces to one or more networks, each of the networks connected to one or more clients, the firewall having one or more memories and one or more central processing units (CPUs) and further comprising:
one or more applications executed by one or more of the CPUs, each application using one or more sockets connected to the networks to communicate over the networks; and
one or more rule sets containing one or more rules; and
one or more databases.

18. [Claim Reference]A firewall according to claim 17, wherein one said database contains digital file fingerprints.

19. [Claim Reference]A firewall according to claim 17, wherein one said application compares digital file fingerprints contained in a said database with a digital file fingerprint in transit on said network.

20. [Claim Reference]A firewall, as in claim 17, wherein the rule set contains a method to identify specific files in transit by their unique digital fingerprint.

21. [Claim Reference]A firewall, as in claim 17, wherein the specific data files are one or more of the following types:
a video file, an audio file, a picture file, a video and audio file, a digital document or other digital file type containing digital data.

22. [Claim Reference]A method according to claim 1, wherein the said file is a digital audio file.

23. [Claim Reference]A method according to claim 1, wherein the said file is a digital video file.

24. [Claim Reference]A method according to claim 1, wherein the said file is a digital text document file.

25. [Claim Reference]A method according to claim 1, wherein the said file is any digital file containing copyrighted content.

26. [Claim Reference]A method according to claim 1, wherein the said file is stored on a PDA (Personal Digital Assistant).

27. [Claim Reference]A method according to claim 1, wherein the said file is stored on a cellular telephone.

28. [Claim Reference]A method according to claim 1, wherein the said file is stored on a digital camera.

29. [Claim Reference]A method according to claim 1, wherein the said file is stored on a digital storage device.

30. [Claim Reference]A method according to claim 1, wherein the said file is compared with signatures in said database when the file is executed.

31. [Claim Reference]A method according to claim 1, wherein the said file is compared with signatures in said database by comparing every file stored on a computer system.

32. [Claim Reference]A method according to claim 1, wherein the said file is compared with signatures in said database at the time the said file is first received on a computer system.

33. [Claim Reference]A method according to claim 6, wherein the said user is alerted with an option of purchasing copyrighted content equivalent to content found in a match.

34. [Claim Reference]A method according to claim 33, wherein the said content may be content already contained on said users computer system through a process of re-encoding said content to a new secure format.

35. [Claim Reference]A method according to claim 1, wherein the said method is executed on a computer system.

36. [Claim Reference]A method according to claim 1, wherein the said method is executed on a PDA (Personal Digital Assistant).

37. [Claim Reference]A method according to claim 1, wherein the said method is executed on cellular telephone.

38. [Claim Reference]A method according to claim 1, wherein the said method is executed on a digital camera.

39. [Claim Reference]A method according to claim 1, wherein the said method is executed on a network appliance.

40. [Claim Reference]A method according to claim 1, wherein the said method is executed on a microchip technology.

41. [Claim Reference]A method according to claim 1, wherein a resulting match in said compare between file signature and file signatures in said database results in a network action or event.

42. [Claim Reference]A method according to claim 1, wherein a resulting match in said compare between file signature and file signatures in said database results in a local computer system action or event.

43. [Claim Reference]A method according to claim 1, wherein a resulting non-match in said compare between file signature and file signatures in said database results in a network action or event.

44. [Claim Reference]A method according to claim 1, wherein a resulting non-match in said compare between file signature and file signatures in said database results in a local computer system action or event.

45. [Claim Reference]A method according to claim 1, wherein a resulting match in said compare results in the user of a computer system being presented with an option to purchase said matching content.

46. [Claim Reference]A method according to claim 1, wherein a resulting match in said compare results in the user of a computer system being presented with an option to delete said matching content.

47. [Claim Reference]A method according to claim 45, wherein the said file is a digital audio file.

48. [Claim Reference]A method according to claim 45, wherein the said file is a digital video file.

49. [Claim Reference]A method according to claim 45, wherein the said file is a digital text document file.

50. [Claim Reference]A method according to claim 45, wherein the said file is any digital file containing copyrighted content.

51. [Claim Reference]A method according to claim 46, wherein the said file is a digital audio file.

52. [Claim Reference]A method according to claim 46, wherein the said file is a digital video file.

53. [Claim Reference]A method according to claim 46, wherein the said file is a digital text document file.

54. [Claim Reference]A method according to claim 46, wherein the said file is any digital file containing copyrighted content.

55. [Claim Reference]A method according to claim 45, wherein the said file is a digital file with file type .ppt, .xls, or .doc.

56. [Claim Reference]A method according to claim 46, wherein the said file is a digital file with file type .ppt, .xls, or .doc.

57. [Claim Reference]A method according to claim 1, wherein the said method is executed on a digital audio player.

58. [Claim Reference]A method according to claim 1, wherein the said file is a digital audio file and is executed for a period of time on a computer system before an action or event occurs.

59. [Claim Reference]A method according to claim 1, wherein the result of a match results in the user being presented with several options.

60. [Claim Reference]A method according to claim 59, wherein one said option is to purchase said matching content.

61. [Claim Reference]A method according to claim 60, wherein said option is communicated through an alert.

62. [Claim Reference]A method according to claim 60, wherein said option is communicated through a web page.

63. [Claim Reference]A method according to claim 60, wherein said option is performed by re-encoding said file as a different file type directly on the said computer system.

64. [Claim Reference]A method according to claim 63, wherein said re-encoded file is of file type AAC.

65. [Claim Reference]A method according to claim 63, wherein said re-encoded file is of the type MP3.

66. [Claim Reference]A method according to claim 63, wherein said re-encoded file is of the type MP4.

67. [Claim Reference]A method according to claim 63, wherein said re-encoded file is of the type AIFF.

68. [Claim Reference]A method according to claim 63, wherein said re-encoded file is of the type MPEG.

69. [Claim Reference]A method according to claim 59, wherein one said option is to delete said matching content.

70. [Claim Reference]A method according to claim 59, wherein one said option is to lease said matching content for a period of time.

71. [Claim Reference]A method according to claim 59, wherein one said option is to take an online class.

72. [Claim Reference]A method according to claim 59, wherein one said option is to request use of a file.

73. [Claim Reference]A method according to claim 72, wherein said file is of the type .doc.

74. [Claim Reference]A method according to claim 72, wherein said file is of the type .xls.

75. [Claim Reference]A method according to claim 72, wherein said file is of the type .ppt.

76. [Claim Reference]A method according to claim 59, wherein one said option is to never allow known matching content to be received or executed.

77. [Claim Reference]A method according to claim 59, wherein one said option is to delete all matching content.

78. [Claim Reference]A method according to claim 1, wherein the said database containing hash signatures is updated via an electronic link.

79. [Claim Reference]A method according to claim 1, wherein the said database containing hash signatures is updated via a dynamic update engine.

80. [Claim Reference]A method according to claim 79, wherein said dynamic update engine is comprised of the following:
an application run on a computer system; and
a search routine; and
a connection to a master database.

81. [Claim Reference]A method according to claim 80, wherein said application is programmed to search for digital content available for transfer on an electronic network link.

82. [Claim Reference]A method according to claim 80, wherein said application is programmed to interact and pass commands to and from the said search routine.

83. [Claim Reference]A method according to claim 81, wherein said digital content is of file type AAC.

84. [Claim Reference]A method according to claim 81, wherein said digital content is of the file type MP3.

85. [Claim Reference]A method according to claim 81, wherein said digital content is of the file type MP4.

86. [Claim Reference]A method according to claim 81, wherein said digital content is of the file type AIFF.

87. [Claim Reference]A method according to claim 81, wherein said digital content is of the file type MPEG.

88. [Claim Reference]A method according to claim 81, wherein said digital content is of the type .doc.

89. [Claim Reference]A method according to claim 81, wherein said digital content is of the type xls.

90. [Claim Reference]A method according to claim 81, wherein said file is of the type .ppt.

91. [Claim Reference]A method according to claim 80, wherein said master database contains a relational list of content based on matching probability.

92. [Claim Reference]A method according to claim 80, wherein said master database communicates with other online databases to communicate relational changes.

93. [Claim Reference]A method according to claim 1, wherein said database communicates with an online master database via an electronic link.

94. [Claim Reference]A method according to claim 81, wherein the said digital content is of the type .JPEG or .JPG.

95. [Claim Reference]A method according to claim 81, wherein the said digital content is of the type .GIF.

96. [Claim Reference]A method according to claim 81, wherein the said digital content is of the type .TIFF or .TIF.

97. [Claim Reference]A method according to claim 1, wherein the said digital content is of the type .JPEG or .JPG.

98. [Claim Reference]A method according to claim 1, wherein the said digital content is of the type .GIF.

99. [Claim Reference]A method according to claim 1, wherein the said digital content is of the type .TIFF or .TIF.

100. [Claim Reference]A method according to claim 45, wherein the said digital content is of the type .JPEG or .JPG.

101. [Claim Reference]A method according to claim 45, wherein the said digital content is of the type .GIF.

102. [Claim Reference]A method according to claim 45, wherein the said digital content is of the type .TIFF or .TIF.

103. [Claim Reference]A method according to claim 46, wherein the said digital content is of the type .JPEG or .JPG.

104. [Claim Reference]A method according to claim 46, wherein the said digital content is of the type .GIF.

105. [Claim Reference]A method according to claim 46, wherein the said digital content is of the type .TIFF or .TIF.

106. [Claim Reference]A method according to claim 72, wherein the said digital content is of the type .JPEG or .JPG.

107. [Claim Reference]A method according to claim 72, wherein the said digital content is of the type .GIF.

108. [Claim Reference]A method according to claim 72, wherein the said digital content is of the type .TIFF or .TIF.

109. [Claim Reference]A method according to claim 72, wherein the said file is a digital audio file.

110. [Claim Reference]A method according to claim 72, wherein the said file is a digital video file.
